(19) United States
(12) Patent Application Publication
(10) Pub. No.: US 2013/0254026 A1
(43) Pub. Date: Sep. 26, 2013

(54) CONTENT FILTERING BASED ON VIRTUAL AND REAL-LIFE ACTIVITIES

(71) Applicants: Naomi HADATSUKI, San Jose, CA (US); Hideaki TANIOKA, San Jose, CA (US)

(72) Inventors: Naomi HADATSUKI, San Jose, CA (US); Hideaki TANIOKA, San Jose, CA (US)

(73) Assignee: FUJITSU LIMITED, Kawasaki-shi (JP)

(21) Appl. No.: 13/429,204

(22) Filed: Mar. 23, 2012

(51) Int. Cl. G06Q 30/02

(52) U.S. Cl. 705/14.53

(57) ABSTRACT

According to an aspect of an embodiment, a method of content filtering is described. The method may include receiving contextual data. The contextual data may indicate virtual activity associated with a user of the communication device and real-life activity associated with the user of the communication device. The method may also include identifying a pattern based on the virtual and real-life activity. The method may also include filtering content based on the identified pattern to present on the communication device.

Example embodiments discussed herein are related to-content filtering based on virtual and real-life activities.

### BACKGROUND

The prolific expansion and utilization of the Internet has made a vast and seemingly ever-increasing amount of content available to users. To find relevant content, users often employ an Internet search engine, and search engines have become an indispensable feature of many users' internet usage. Numerous techniques are known for search engines to enquire, catalogue and prioritize websites according to predetermined categories and/or according to the particular search query to identify content that the search engine believes is most relevant to the user. Nevertheless finding relevant content may still be difficult for users using known techniques.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of content filtering is described. The method may include receiving contextual data. The contextual data may indicate virtual activity associated with a user of a communication device and real-life activity associated with the user of the communication device. The method may also include identifying a pattern based on the virtual and real-life activity. The method may also include filtering content based on the identified pattern to present on the communication device.

The object and advantages of the embodiments will be realized and achieved by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example operating environment in which content filtering may be provided at a communication device;

FIG. 2 is a block diagram of an embodiment of a communication device that may be implemented in the operating environment of FIG. 1;

FIG. 3 is a flowchart of an example method of providing content filtering to be presented at a communication device; and

FIG. 4 is a block diagram illustrating an example computing device that is arranged for filtering content, all arranged in accordance with at least some embodiments described herein.

### DESCRIPTION OF EMBODIMENTS

According to some embodiments described herein, communication devices, such as cell phones, smartphones, personal digital assistants (PDA's), tablets, and the like may be used to deliver content, such as advertisements to a user of the communication device. In order to deliver content which is more relevant to the user, the content may be filtered based on patterns identified among the user's real-life activities and virtual life activities.

A communication device may be used to determine a user's virtual activity. For example, a user may use the communication device to search for a coffee shop. A communication device may alternately or additionally be used to determine the user's real life activity. Continuing in the example above, the communication device may be used to monitor the user's location when the search for a coffee shop is performed. Further, the user may search for a coffee shop at a particular time each day. A pattern may be identified based on the virtual activity and the real-life activity to deliver content, such as a coupon for coffee, to the user at the particular time of day, according to the identified pattern.

According to some embodiments described herein, implementing content filtering at the communication device may be facilitated by local hardware and/or local software of the communication device. Alternately or additionally, implementing content filtering at the communication device may be facilitated by a cloud computing system in cooperation with an application at the communication device. In these and other embodiments, content filtering may be implemented by identifying a pattern based on virtual activities and real-life activities associated with the user of the communication device.

Embodiments of the present invention will be explained with reference to the accompanying drawings.

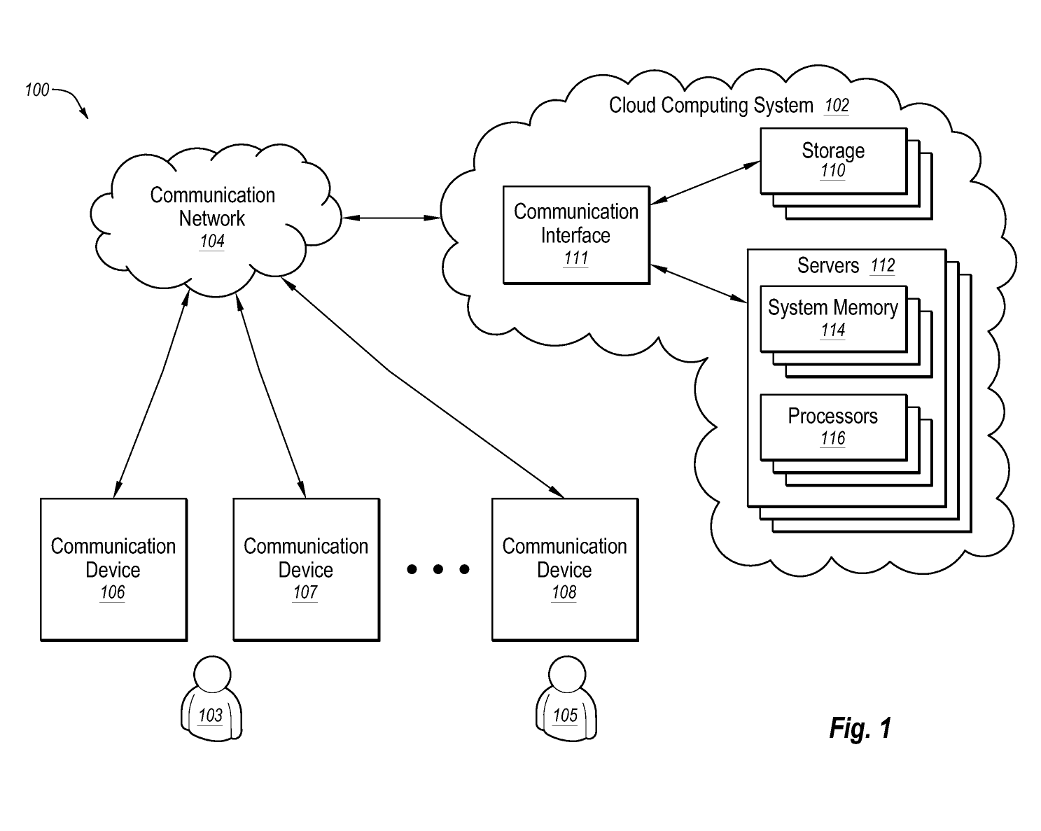

FIG. 1 illustrates an example operating environment 100 in which content filtering may be provided at a communication device, arranged in accordance with at least some embodiments described herein. The operating environment 100 may include a cloud computing system 102, a communication network 104, one or more communication devices 106, 107, 108, and one or more users 103, 105 associated with the one or more communication devices 106, 107, 108.

In general, the communication network 104 may include one or more wide area networks (WANs) and/or local area networks (LANs) that enable the cloud computing system 102 and the communication devices 106, 107, 108 to communicate with each other. In some embodiments, the communication network 104 includes the Internet, including a global internetwork formed by logical and physical connections between multiple WANs and/or LANs. Alternately or additionally, the communication network 104 may include one or more cellular RF networks and/or one or more wired and/or wireless networks such as, but not limited to, 802.xx networks, Bluetooth access points, wireless access points, IP-based networks, or the like. The communication network 104 may also include servers that enable one type of network to interface with another type of network.

Each of the communication devices 106, 107, 108 may include, but is not limited to: a mobile phone, a smartphone, a personal digital assistant (PDA), a personal music device such as an .mp3 player, a pager, an electronic book reader, or a tablet computer. Moreover, each of the communication devices 106, 107, 108 may include one or more sensors including, but not limited to: a photovoltaic sensor; an auditory sensor; a location sensor; a proximity sensor; an accelerometer; a tactile sensor; or a clock. In some embodiments, each of the communication devices 106, 107, 108 may also include a communication interface, discussed in more detail below, to allow access to services provided by the cloud computing system 102. For example, each of the communication devices 106, 107, 108 may use corresponding communication interfaces to provide contextual data to the cloud computing system 102. The cloud computing system 102 may receive the contextual data from the one or more communication devices 106, 107, 108, and provide filtered content to the one or more communication devices 106, 107, 108.

The cloud computing system 102 may include one or more hardware systems. For example, the cloud computing system 102 may include, but is not limited to, one or more storage devices 110, a communication interface 111, and one or more servers 112. Each of the one or more servers 112 may include one or more system memory devices 114 and one or more processors 116.

The storage devices 110 may include non-volatile storage such as magnetic storage, optical storage, solid state storage, or the like or any combination thereof. The storage devices 110 may be communicatively coupled to the communication interface 111.

The servers 112 may each include one or more system memory devices 114 and/or one or more processors 116 and may be configured to execute software to run and/or provide access to the cloud computing system 102, and/or to execute software that may be available in the cloud computing system 102, to the one or more communication devices 106, 107, 108.

Each system memory device 114 may include volatile storage such as random access memory (RAM). Each system memory device 114 may have loaded therein programs and/or software that may be executed by one or more of the processors 116 to perform one or more of the operations described herein, such as filtering content to present at the one or more communication devices 106, 107, 108.

The communication interface 111 of the cloud computing system 102 may be configured to receive contextual data from any of the communication devices 106, 107, 108, and/or to send filtered content to any of the communication devices 106, 107, 108. The communication interface 111 may include, for example, a network interface card, a network adapter, a LAN adapter, or other suitable communication interface.

The contextual data may include both usage data and sensor data. The usage data may indicate virtual activity associated with the user 103 of the communication device 106, and may include, for instance, online searching activity of the user 103, online transaction(s) of the user 103, online browsing history of the user 103, and/or other virtual activity of the user 103. The sensor data may indicate real-life activity associated with the user 103 of the communication device 106. The sensor data may include data indicating one or more of: a real-life location, a real-life movement, or a real-life transaction. While described in the context of the user 103 of the communication device 106, the contextual data may more generally relate to virtually any user and associated communication device.

Accordingly, the cloud computing system 102 may receive contextual data from any of the communication devices 106, 107, 108, and/or send filtered content to any of the communication devices 106, 107, 108. For example, the cloud computing system may receive, via the communication interface 111, contextual data from the communication device 106. The contextual data may indicate virtual activity associated with the user 103 of the communication device 106, and real-life activity associated with the user 103 of the communication device 106.

The cloud computing system 102 may store the contextual data at the storage devices 110 coupled to the communication interface 111 or in another suitable location or device. Alternately or additionally, the contextual data may be loaded to the system memory device 114 for access by the processor 116. The processor 116 may identify a pattern based on the virtual and real-life activity, and may filter content to present on the communication device 106 based on the identified pattern.

For example, the contextual data may indicate virtual activity of the user 103 such as searching for a coffee shop using the communication device 106. Alternately or additionally, the contextual data may indicate real-life activity of the user 103 such as purchasing a coffee from a coffee shop. Data indicative of such real-life activity may be collected by one or more sensors of the communication device 106, such as a proximity sensor including a near field communication (NFC) sensor, a location sensor, or the like. Alternately or additionally, the real-life data may also include a time of the search for the coffee shop, and/or the time of the coffee purchase.

A pattern may be identified by the processor 116 based on the contextual data. For instance, continuing with the previous example, the processor 116 may identify a pattern of the user 103 searching for a coffee shop at an identified time of day and/or purchasing a coffee at an identified time of day using the communication device 106.

Based on the identified pattern, the processor 116 may then filter content to present on the communication device 106. The filtered content may include, for example, a coupon from the coffee shop that the user 103 frequents for an item not typically purchased by the user 103 when visiting the coffee shop, e.g., an upsell. Alternately or additionally, the filtered content may include, for example, a coupon from a different coffee shop seeking to promote their business.

In either of the foregoing examples, the coupon or other filtered content may be presented at or near the identified time of day. For instance, in the case of the coupon from the coffee shop typically visited by the user 103, the coupon may be presented at or near the time when, according to the identified pattern, the user 103 may be at the coffee shop. Alternately, in the case of the coupon from the different coffee shop, and depending on the locations of the two coffee shops relative to the user 103, the coupon may be presented at or a near time when, according to the identified pattern, the user 103 has not yet begun moving toward the coffee shop typically visited by the user 103.

Alternately or additionally, the pattern may incorporate subsequent activities of a user. When subsequent activities of a user are incorporated, the contextual data may be first contextual data. The communication interface 111 may be configured to receive second contextual data indicating subsequent virtual activity and/or subsequent real-life activity. The processor 116 may then identify a pattern based on the first contextual data as well as the second contextual data, and more generally based on any amount of data collected over any amount of time.

For example, the user 103 may purchase a coffee using the NFC sensor of the communication device 106 one day at an identified time. The real-life activity of purchasing the coffee may be represented by the first contextual data. The user 103 may then purchase a coffee using the NFC sensor a subsequent day at an identified time using the communication device 106. The subsequent day's real-life activity may be the second contextual data. The processor 116 may identify a pattern based on both the first contextual data and the second contextual data, which identified pattern may then be used to filter content as described herein.

Alternately or additionally, the cloud computing system 102 may provide, e.g., via the communication interface 111, the identified pattern to the communication device 106. The communication device 106 may gather second contextual data indicating subsequent virtual activity and/or subsequent real-life activity and being similar to the first contextual data. The communication device 106 may then filter content based on the identified pattern provided by the cloud computing system 102.

For example, the communication device 106 may provide to the communication interface 111 first contextual data including usage data and sensor data. The processor 116 in the cloud computing system 102 may identify a pattern based on the first contextual data and the communication interface 111 may provide the pattern to the communication device 106. The communication device 106 may then filter content based on the pattern provided by the communication interface 111, to present, for example a promotion by a coffee shop. Alternately or additionally, the user 103's subsequent virtual and/or real-life activity may result in second or subsequent contextual data that may be subsequently used by the communication device 106 to filter content in connection with the identified pattern, and/or to confirm or adjust the identified pattern

Alternately or additionally, the cloud computing system 102 may be configured to filter the content according to the identified pattern and to provide the filtered content to a second communication device associated with the same user as the first communication device. By way of example, both of the communication devices 106, 107 may be associated with the same user 103 in FIG. 1 and a pattern identified based on contextual data collected from the communication device 106 may be used by the cloud computing system 102 to filter content presented on the communication device 107.

Alternately or additionally, the pattern identified from the contextual data collected by the communication device 106 may be provided by the communication interface 111 to the communication device 107. In these and other embodiments, the communication device 107 may filter content to present to the user 103 based on the identified pattern received from the cloud computing system 102.

Accordingly, some embodiments described herein may include identifying a pattern based on both virtual and real-life activity of a user, and then filtering content to present to the user based on the identified pattern. The identification of the pattern and/or the filtering of content may be performed at the cloud computing system 102 in some embodiments. Alternately or additionally, the identification of the pattern and/or the filtering of the content may be performed locally at a communication device, as described in more detail below.

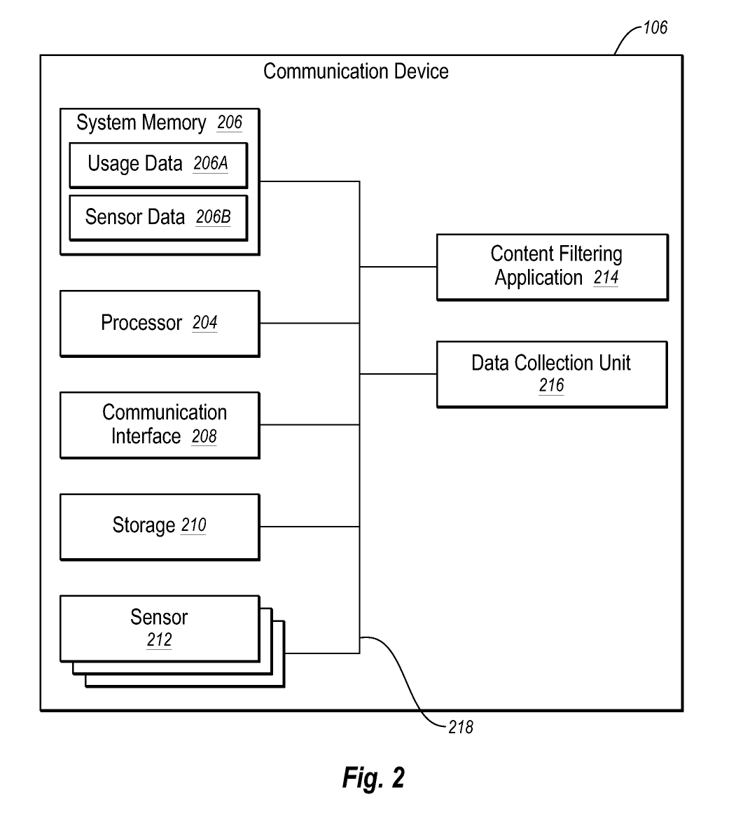

FIG. 2 is a block diagram of an embodiment of the communication device 106 of FIG. 1, arranged in accordance with at least some embodiments described herein. One or more of the communication device 107 and communication device 108 may be similarly configured. The communication device 106 may include a processor 204 or other processing device, a system memory device 206, a communication interface 208, a storage device 210, one or more sensors 212, a content filtering application 214, a data collection unit 216 configured to receive contextual data, and a communication bus 218 configured to communicably couple the foregoing components to each other.

The processor 204 may be configured to perform one or more of the operations described herein, such as identifying a pattern and filtering content to be presented at the communication device 106 as discussed in more detail below. The processor may be configured to perform such operations by executing computer-readable instructions loaded into the system memory device 206, for example.

The system memory device 206 may include programs and/or software loaded therein that may be executed by the processor 204 to facilitate identifying the pattern and filtering content to present at the communication device 106. Alternately or additionally, contextual data, such as usage data 206A, sensor data 206B, and/or other data, may be loaded to the system memory device 206 during execution of the programs and/or software.

The communication interface 208 of the communication device 106 may be configured to provide contextual data to the cloud computing system 102 of FIG. 1, and/or may be otherwise configured to facilitate communication with the cloud computing system 102 and/or other communication devices 107, 108. Similar to the communication interface 111 of the cloud computing system 102 of FIG. 1, the communication interface 208 may include, for example, a network interface card, a network adapter, a LAN adapter, or other suitable communication interface.

The storage device 210 may include non-volatile storage such as magnetic storage, optical storage, solid state storage, or the like or any combination thereof. Similar to the system memory device 206, the storage device 210 may be configured to store contextual data, such as usage data 206A and/or sensor data 206B.

The one or more sensors 212 may include, for example: a photovoltaic sensor; an auditory sensor; a location sensor; a proximity sensor; an accelerometer; a tactile sensor; and/or a clock.

The content filtering application 214 may include software, such as computer-readable instructions stored in the storage device 210 and/or loaded in the system memory device 206, which is executable by the processor 204 to execute content filtering at the communication device 106.

The data collection unit 216 may be configured to receive contextual data generated at the communication device 106 by, e.g., the one or more sensors 212. The data collection unit 216 may be included in the system memory device 206, for example. The contextual data gathered by the data collection unit 216 may indicate virtual activity and real-life activity associated with a user, such as the user 103, of the communication device 106.

The contextual data may include usage data 206A and/or sensor data 206B. The usage data 206A may indicate the virtual activity associated with the user 103 of the communication device 106, and may include, for instance, online searching activity of the user 103, online transaction(s) of the user 103, online browsing history of the user 103, and/or other virtual activity of the user 103. The sensor data 206B, e.g., from the one or more sensors 212, may indicate real-life activity associated with the user 103 of the communication device 106, and may include one or more of: a real-life location, a real-life movement, a real-life engagement of the communication device by the user; and/or a real-life transaction. The processor 204 may be configured to identify the pattern based on the virtual activity and real-life activity of the user 103 indicated by the contextual data, and may be configured to filter content based on the identified pattern to present on the communication device 106.

For example, the contextual data may indicate virtual activity of the user 103 such as searching for a coffee shop using the communication device 106. Alternately or additionally, the contextual data may indicate real-life activity of the user 103 such as purchasing a coffee from a coffee shop. Data indicative of such real-life activity may be collected by one or more sensors of the communication device 106, such as a proximity sensor including a near field communication (NFC) sensor, a location sensor, or the like. Alternately or additionally, the real-life data may also include a time of the search for the coffee shop, and/or the time of the coffee purchase.

A pattern may be identified by the processor 204 based on the contextual data. For instance, continuing with the previous example, the processor 116 may identify a pattern of the user 103 is searching for a coffee shop at an identified time of day and/or purchasing a coffee at an identified time of day using the communication device 106.

Based on the identified pattern, the processor 204 may then filter content to present on the communication device 106. The filtered content may include, for example, a coupon from the coffee shop that the user 103 frequents for an item not typically purchased by the user 103 when visiting the coffee shop, e.g., an upsell. Alternately or additionally, the filtered content may include, for example, a coupon from a different coffee shop seeking to promote their business, and presented at the identified time of day.

In either of the foregoing examples, the coupon or other filtered content may be presented at or near the identified time of day. For instance, in the case of the coupon from the coffee shop typically visited by the user 103, the coupon may be presented at or near the time when, according to the identified pattern, the user 103 may be at the coffee shop. Alternately, in the case of the coupon from the different coffee shop, and depending on the locations of the two coffee shops relative to the user 103, the coupon may be presented at or a near time when, according to the identified pattern, the user 103 has not yet begun moving toward the coffee shop typically visited by the user 103.

Alternately or additionally, the pattern may incorporate subsequent activities of a user. When subsequent activities of a user are incorporated, the contextual data may be first contextual data. The data collection unit 216 may be configured to receive second contextual data indicating subsequent virtual activity and/or subsequent real-life activity. The processor 204 may then identify a pattern based on the first contextual data as well as the second contextual data, and more generally based on any amount of data collected over any amount of time.

For example, the user 103 may purchase a coffee using the NFC sensor of the communication device 103 a first day at an identified time. The real-life activity of purchasing the coffee may be represented by the first contextual data. The user 103 may then purchase a coffee using the NFC sensor a subsequent day at an identified time using the communication device 106. The subsequent day's real-life activity may be the second contextual data. The processor 204 may identify a pattern based on both the first contextual data and the second contextual data, which identified pattern may then be used to filter content as described herein.

Alternately or additionally, the real-life activity may include engagement of the communication device 106 by the user 103. For example, there may be a period of inactivity when the user 103 of the communication device 106 may not engage the communication device 103, followed by engagement of the communication device 106 by the user. The engagement by the user 103 may be via a touchscreen interface of the communication device 106. The touchscreen interface may function as a tactile sensor and/or the communication device 106 may otherwise include a tactile sensor. In these and other embodiments, the communication device 106 may present filtered content to the user 103 upon engagement of the communication device 106 via the touchscreen interface of the communication device 106. Alternately or additionally, the processor 204 may incorporate data relating to the periods of inactivity and the engagement of the communication device 106 via the touchscreen interface in the contextual data used to identify patterns.

Alternately or additionally, the communication device 106 may provide, e.g., via the communication interface 208, the first and/or second (or subsequent) contextual data to the cloud computing system 102. The cloud computing system 102 may identify a pattern based on the virtual and real-life activity indicated by the first contextual data. The communication device 106 may gather second contextual data indicating subsequent virtual activity and/or subsequent real-life activity and being similar to the first contextual data. The second contextual data may be provided to the cloud computing system via the communication interface 208. The cloud computing system may identify a pattern based on one or both of the second contextual data and the first contextual data. The cloud computing system 102 may then filter content based on the identified pattern and provide filtered content to the communication device 106.

Alternately or additionally, the identified pattern, whether identified at the communication device 106 or the cloud computing system 102, may be used by the cloud computing system 102 to filter content for the other communication device 107 associated with the user 103, or the identified pattern may be provided directly to the communication device 107 to locally filter content to present to the user according to the identified pattern.

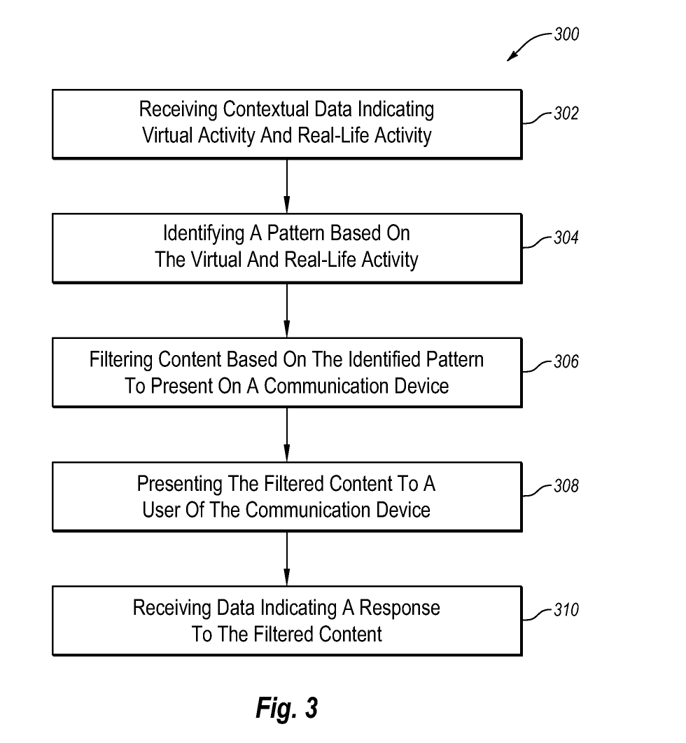

FIG. 3 is a flowchart of an example method 300 to filter content, arranged in accordance with at least some embodiments described herein. In some embodiments, the method 300 may be performed in whole or in part by a cloud computing system, such as the cloud computing system 102 of FIG. 1. Alternately or additionally, the method 300 may be performed in whole or in part by a communication device, such as the communication device 106 of FIG. 1.

The method 300 may begin at block 302 in which contextual data is received. The contextual data may be received by, e.g., the data collection unit 216 of the communication device 106, or by the communication interface 111 of the cloud computing system 102. As already explained herein, the contextual data may indicate virtual activity and real-life activity associated with a user of a communication device.

The method 300 may continue at block 304 in which a pattern is identified based on the virtual and real-life activity. The pattern may be identified by a processor, such as the processor 116 of the cloud computing system 102 or the processor 204 of the communication device 106, and may be configured to identify a pattern based on the virtual and real-life activity associated with the user of the communication device.

The method 300 may continue at block 306 in which content is filtered, based on the identified pattern, to present on the communication device.

The method 300 may continue at block 308 in which the filtered content is presented on the communication device to a user of the communication device, such as the user 103 in FIG. 1.

The method 300 may continue at block 310 in which data indicating a response to the filtered content is received.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, the contextual data may include usage data and sensor data, such as the usage data 206A and the sensor data 206B depicted in FIG. 2. As described above, the usage data 206A may indicate the virtual activity associated with the user 103. The sensor data 206B may indicate the real-life activity associated with the user 103.

Alternately or additionally, the contextual data may include first contextual data, and the method may further include receiving second contextual data indicating subsequent virtual activity and/or subsequent real-life activity. Although not illustrated in FIG. 3, the method may alternately or additionally include identifying the pattern based on second contextual data as well as the first contextual data.

Alternately or additionally, the communication device may be a first communication device, such as the communication device 106 of FIG. 1. The method 300 may further include providing filtered content based on the identified pattern to present on a second communication device, such as the communication device 107. As explained above, when the first communication device and the second communication device are associated with the user, the method may provide filtered content to the second communication device based on the pattern identified from contextual data collected at the first communication device.

Alternately or additionally, the method 300 may be performed at a cloud computing system, such as the cloud computing system 102 depicted in FIG. 1. The method 300 may provide filtered content to the one or more communication devices, such as the one or more communication devices 106, 107, 108 depicted in FIG. 1, via a pattern identified at each communication device or remotely at the cloud computing system, for example.

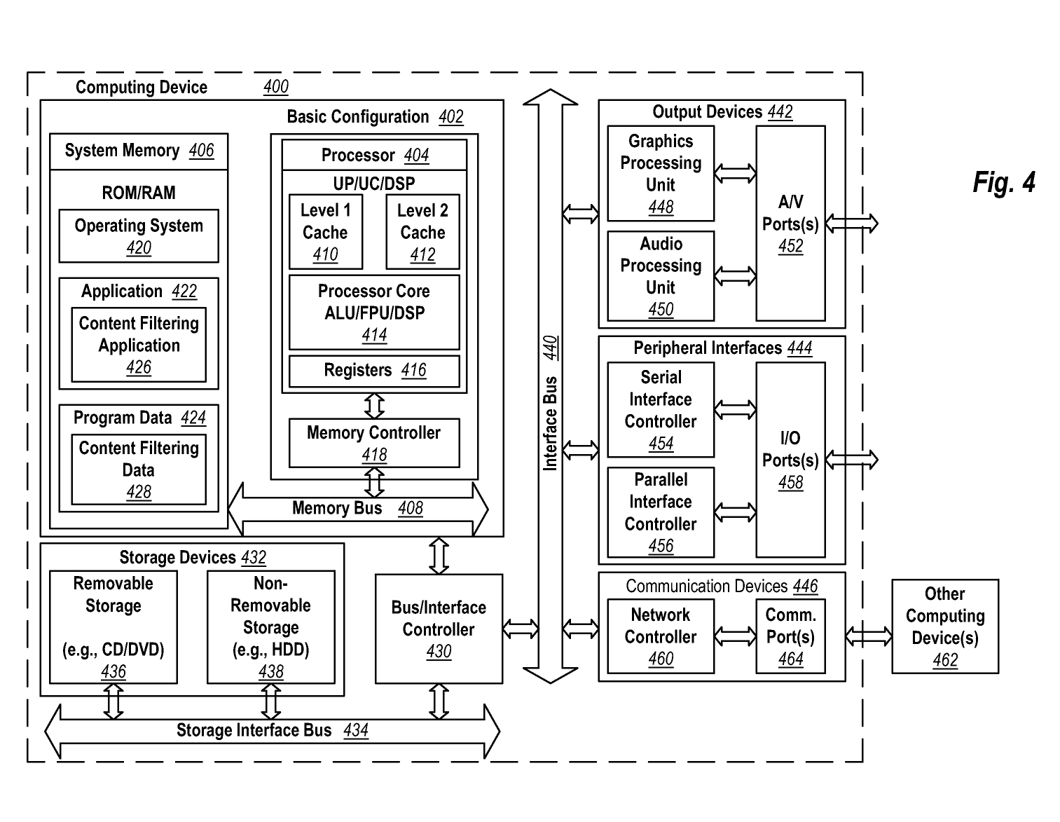

FIG. 4 is a is a block diagram illustrating an example computing device 400 that is arranged for filtering content, arranged in accordance with the present disclosure. The computing device 400 may correspond to one or more of the communication devices 106, 107, 108 or servers 112 of FIG. 1, for example. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include a content filtering application 426 that is arranged to cooperate with other components of the communication device 106 or the cloud computing system 102 to identify patterns based on contextual data indicating virtual and real-life activity of a user and/or to filter content to present to the user according to the identified patterns, as discussed herein. Program data 424 may include content filtering data 428 that may be useful for identifying patterns and/or filtering content according to the identified patterns as described herein. For example, content filtering data 428 may include contextual data indicating virtual activity and real-life activity of the user as described herein, and/or one or more identified patterns. In some embodiments, application 422 may be arranged to operate with program data 424 on operating system 420 such that identification of patterns and content filtering according to the identified patterns may be provided as described herein.

Computing device 400 may have additional features or functionality, and additional interfaces to facilitate communications between basic configuration 402 and any other devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a communication device, such as the communication device 106 in FIG. 1. The communication device 106 may be a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a portion of a cloud computing system, such as the cloud computing system 102 in FIG. 1.

All examples and conditional language recited herein are intended for pedagogical objects to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although embodiments of the present inventions have been described in detail, it should be understood that the various changes, substitutions, and alterations could be made hereto without departing from the spirit and scope of the invention.

What is claimed is:

1. A communication device comprising:
a data collection unit configured to receive contextual data at the communication device, the contextual data indicating:
a virtual activity associated with a user of the communication device; and
a real-life activity associated with the user of the communication device; and
a processing device configured to:
identify a pattern based on the virtual activity and the real-life activity; and
filter content to present on the communication device based on the identified pattern.

2. The communication device of claim 1, the contextual data comprising:
usage data indicating the virtual activity, the usage data including at least one of:
online searching activity of the user;
one or more online transactions of the user; and
a browsing history of the user; and
sensor data indicating the real-life activity, the sensor data including data indicating at least one of:
a real-life location of the user;
a real-life movement of the user;
a real-life engagement of the communication device by the user; and
a real-life transaction of the user.

3. The communication device of claim 2, further comprising one or more sensors configured to collect the sensor data.

4. The communication device of claim 3, wherein the one or more sensors comprise at least one of:
a photovoltaic sensor;
an auditory sensor;
a location sensor;
a proximity sensor;
an accelerometer;
a tactile sensor; and
a clock.

5. The communication device of claim 3, wherein:
the contextual data is first contextual data;
the data collection unit is further configured to receive second contextual data indicating subsequent virtual activity and/or subsequent real-life activity; and
the processing device is further configured to identify the pattern based on the second contextual data.

6. The communication device of claim 1, wherein:
the contextual data is first contextual data;
the data collection unit is further configured to receive second contextual data indicating subsequent virtual activity and/or subsequent real-life activity of the user; and
the communication device further comprising a communication interface configured to:
provide one or both of the first and second contextual data to a cloud computing system; and
receive, from the cloud computing system, data indicating a pattern identified by the cloud computing system based on the virtual and real-life activity of one or both of the first and second contextual data.

7. The communication device of claim 6, wherein
the communication device is a first communication device; and
the cloud computing system is further configured to provide filtered content to present on a second communication device associated with the user based on the pattern identified at the cloud computing system.

8. The communication device of claim 1, further comprising a communication interface, wherein:
the contextual data is first contextual data;
the communication interface is configured to provide second contextual data to a cloud computing system;
the second contextual data being a duplicate of the first contextual data; and
the cloud computing system is configured to:
identify a pattern based on the second contextual data, and
filter content to present at the communication device based on a pattern identified at the cloud computing system.

9. A cloud computing system, comprising:
a communication interface configured to receive contextual data from a communication device external to the cloud computing system, the contextual data indicating:
virtual activity associated with a user of the communication device; and
real-life activity associated with the user of the communication device; and
a storage device coupled to the communication interface and configured to store the contextual data; and
a processing device configured to:
identify a pattern based on the virtual activity and the real-life activity indicated by the contextual data stored in the storage device; and
filter content to present on the communication device based on the identified pattern.

10. The cloud computing system of claim 9, the contextual data comprising:
usage data indicating the virtual activity, the usage data including at least one of:
online searching activity of the user;
one or more online transactions of the user; and
a browsing history of the user; and
sensor data indicating the real-life activity, the sensor data including data indicating at least one of:
a real-life location of the user;
a real-life movement of the user; and
a real-life transaction of the user.

11. The cloud computing system of claim 10, the communication device further comprising one or more sensors configured to collect the sensor data.

12. The cloud computing system of claim 11, wherein the one or more sensors comprise at least one of:
a photovoltaic sensor;
an auditory sensor;
a location sensor;
a proximity sensor;
an accelerometer;
a tactile sensor; and
a clock.

13. The cloud computing system of claim 9, wherein:
the contextual data is first contextual data;
the communication interface is further configured to receive second contextual data indicating subsequent virtual activity and/or subsequent real-life activity of the user; and
the processing device is further configured to identify the pattern based on the second contextual data.

14. The cloud computing system of claim 13, wherein
the communication device is a first communication device; and
the processing device is further configured to filter content, based on the identified pattern, to present on a second communication device associated with the user.

15. A method of content filtering, comprising:
receiving contextual data indicating:
virtual activity associated with a user of a communication device; and
real-life activity associated with the user of the communication device;
identifying a pattern based on the virtual activity and the real-life activity; and
filtering content based on the identified pattern to present on the communication device.

16. The method of claim 15, the contextual data comprising:
usage data indicating the virtual activity, the usage data including at least one of:
online searching activity of the user;
one or more online transactions of the user; and
a browsing history of the user; and
sensor data indicating the real-life activity, the sensor data including data indicating at least one of:
a real-life location of the user;
a real-life movement of the user; and
a real-life transaction of the user.

17. The method of claim 15, wherein the contextual data is first contextual data, the method further comprising:
presenting the filtered content to a user of the communication device; and
receiving data indicating a response to the filtered content.

18. The method of claim 15, wherein the communication device is a first communication device, the method further comprising providing filtered content, based on the identified pattern, to present on a second communication device associated with the user.

19. The method of claim 15, wherein the method is performed at a cloud computing system, further comprising providing the filtered content to one or more communication devices associated with the user to present on the one or more communication devices.

20. A computer-readable storage medium having computer-executable instructions stored thereon that are executable by a processing device to perform the method of claim 15.
